(19) United States
(12) Patent Application Publication
(10) Pub. No.: US 2025/0392175 A1
(43) Pub. Date: Dec. 25, 2025

(54) IMMERSION COOLING LAMINATION

(71) Applicant: Dana Automotive Systems Group, LLC, Maumee, OH (US)

(72) Inventors: Christopher M. COOK, McKenzie, TN (US); Jason M. TYRUS, New Lenox, IL (US)

(21) Appl. No.: 19/245,078

(22) Filed: Jun. 20, 2025

Related U.S. Application Data
(60) Provisional application No. 63/662,593, filed on Jun. 21, 2024.

(51) Int. Cl. H02K 1/16; H02K 9/193; H02K 15/026; H02K 15/027; H02K 15/0273

(52) U.S. Cl. CPC H02K 1/16; H02K 9/193; H02K 15/026; H02K 15/027; H02K 15/0273; H02K 2215/00

(57) ABSTRACT

Systems and methods are provided for a coated lamination layer for an electric motor. The coated lamination layer includes a lamination layer base of annular shape defined by an inner edge and an outer edge with a plurality of radially arranged slot openings and a plurality of radially arranged channel openings, and a sealing layer protruding from a surface of the lamination layer base, wherein the sealing layer is a screen-printed coating. The coated laminations layers are stacked into a stator with the sealing layers sealing regions between the lamination layer bases.

### CROSS-REFERENCE TO RELATED APPLICATION

The present application claims priority to U.S. Provisional Application No. 63/662,593, entitled “Immersion Cooling Lamination”, and filed on Jun. 21, 2024. The entire contents of the above-listed application are hereby incorporated by reference for all purposes.

### TECHNICAL FIELD

The present description relates generally to immersion cooling lamination for electric motors.

### BACKGROUND AND SUMMARY

Immersion cooling of a stator in an electric motor may involve a flow of coolant (e.g., oil) through slots in the stator where windings are positioned, thereby increasing heat transfer area and thus heat removed from the windings in comparison to cooling systems where coolant does not flow into slots of the stator and only surrounds ends of the windings. However, the stator includes multiple lamination layers that are bonded by an adhesive. The adhesive may provide a leak path through which coolant fluid may flow into a cavity of the stator where the rotor is located. The leaked fluid may increase drag losses on rotor rotation, decreasing efficiency of the electric motor.

Thus, the inventors developed systems and manufacturing methods for electric machines that address at least some of the issues described above. The electric machine system includes, in one example, a coated lamination layer with a lamination layer base and a sealing layer. In one example, the lamination layer base is of annular shape defined by an inner edge and an outer edge with a plurality of radially arranged slot openings and a plurality of radially arranged channel openings. The sealing layer protrudes from a surface of the lamination layer base and includes a discontinuous pattern that partially covers the surface. In this way, pressure load upon compressively stacking the coated lamination layers may be concentrated at the sealing sections to form seals between the lamination layer bases. The sealing sections may be positioned, shaped, and sized to seal regions of the stator from one another. For example, the seals may seal a bore in the stator where a rotor is placed when the machine is assembled. The seals may also seal slots defined by the slot openings through which coolant fluid flows. Further, the sealing layer may be a screen-printed coating that includes a coating material with plastic and elastic properties such that the coating material flows to match surface finish profiles of the lamination layer base during screen-printing and during compression, respectively. In this way, the chance of fluid leaks between the lamination layer base and the sealing layer are reduced (e.g., avoided), thereby increasing sealing effectiveness of the sealing layer.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic of an electric motor with an immersion cooling system.

FIG. 2 shows a lamination layer base of a coated lamination layer.

FIG. 3 shows an example of a coated lamination layer.

FIG. 4 shows another example of a coated lamination layer.

FIG. 5 shows a stator including multiple coated lamination layers.

FIG. 6 shows the stator, depicted in FIG. 5, with windings extending therethrough.

FIG. 7 shows an example of the electric motor and immersion cooling system.

FIG. 8 shows a flowchart of a method for manufacturing a coated lamination layer in accordance with the present disclosure.

### DETAILED DESCRIPTION

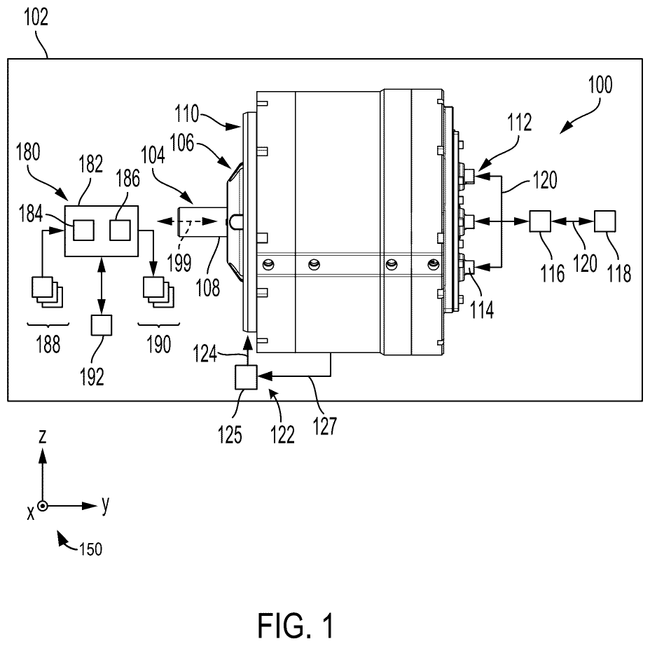

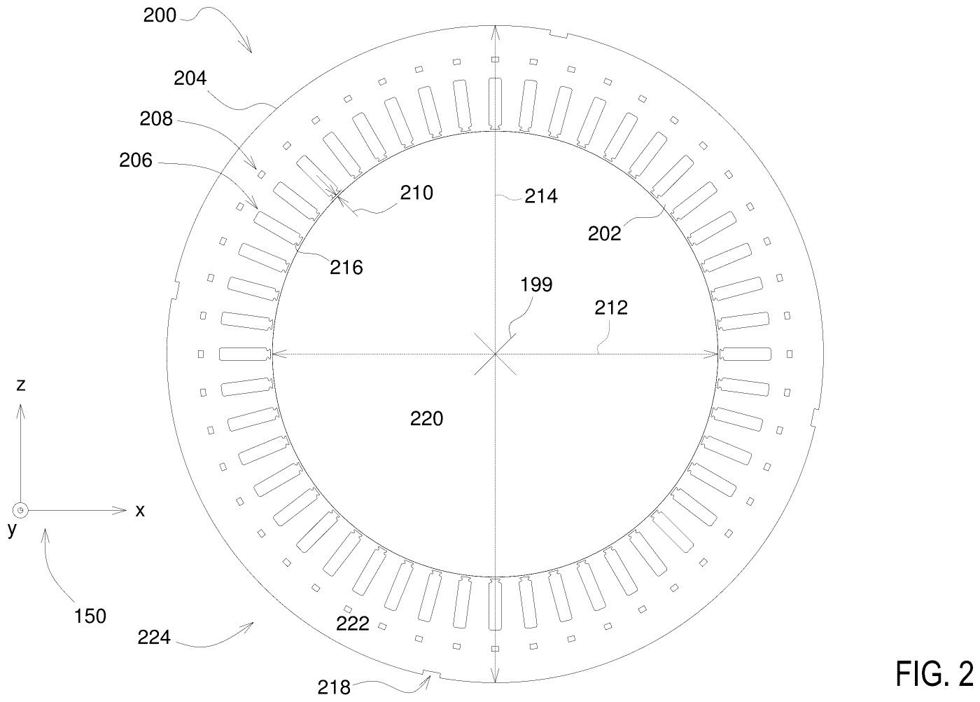

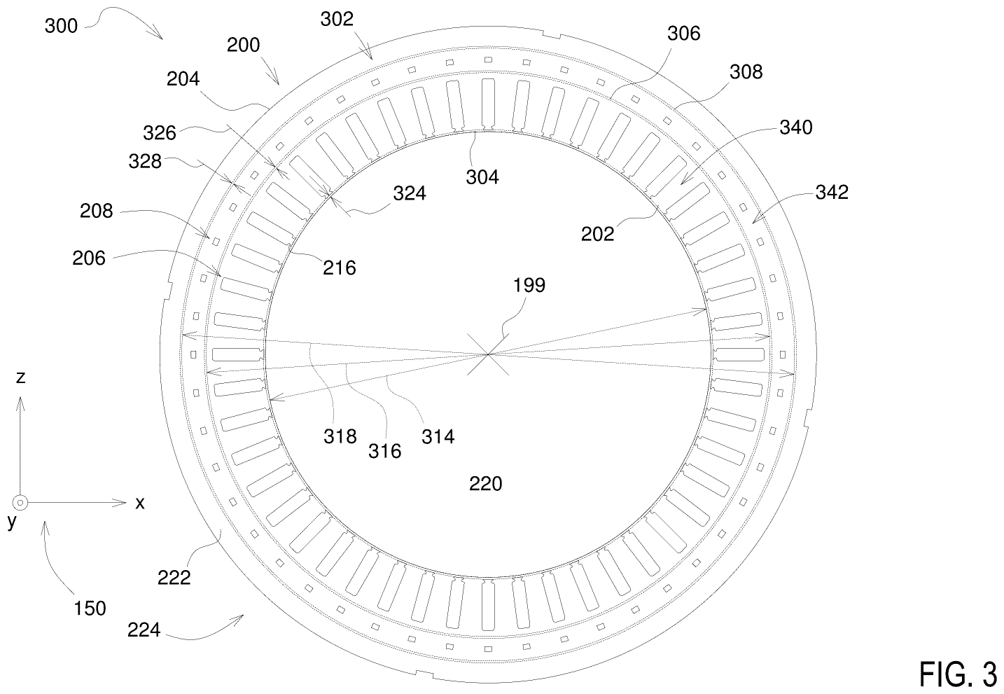

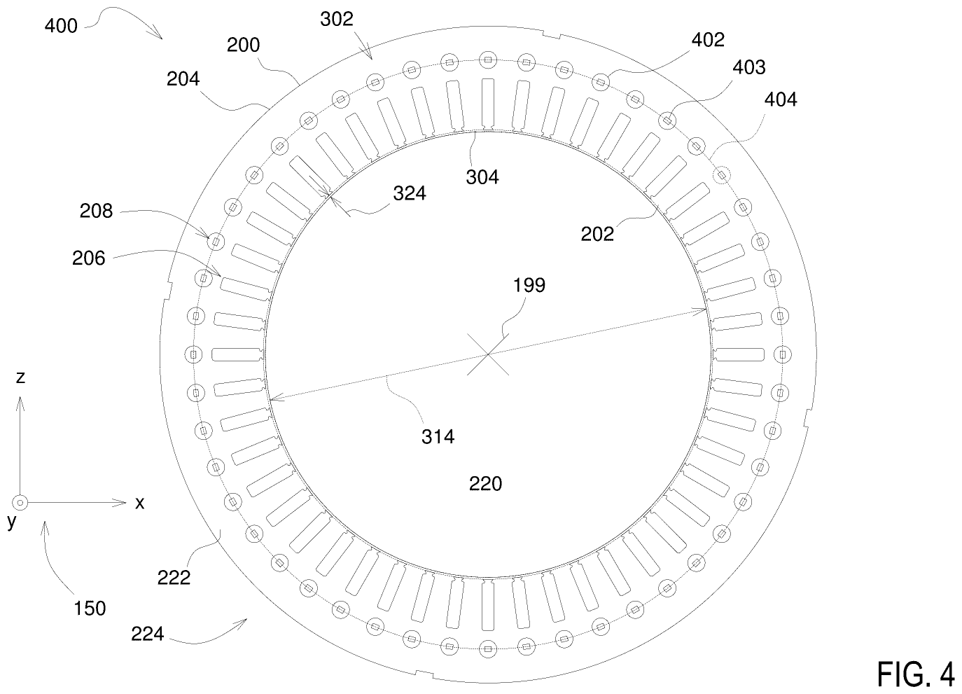

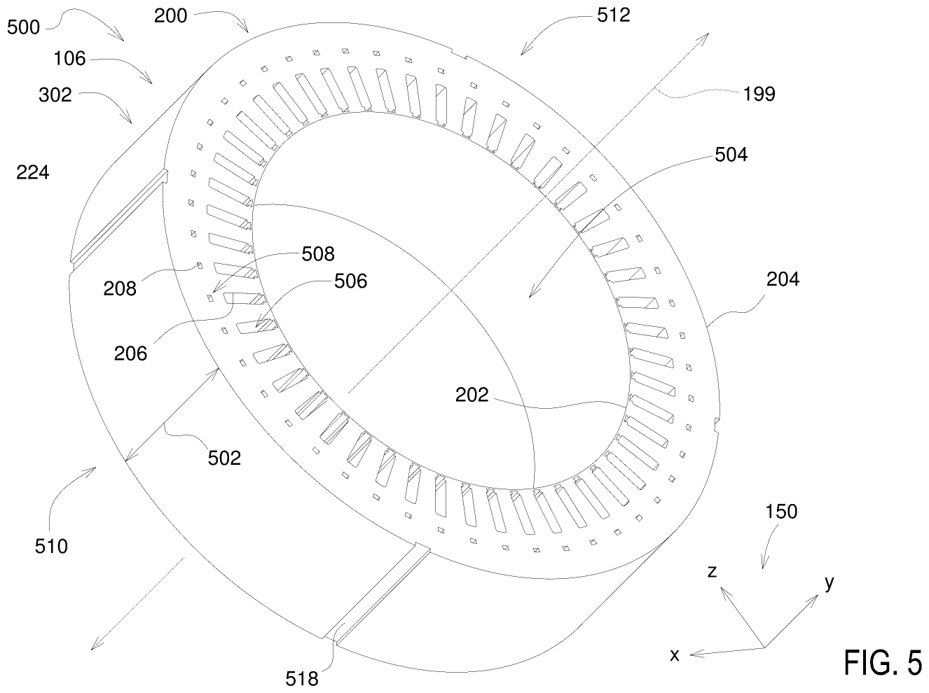

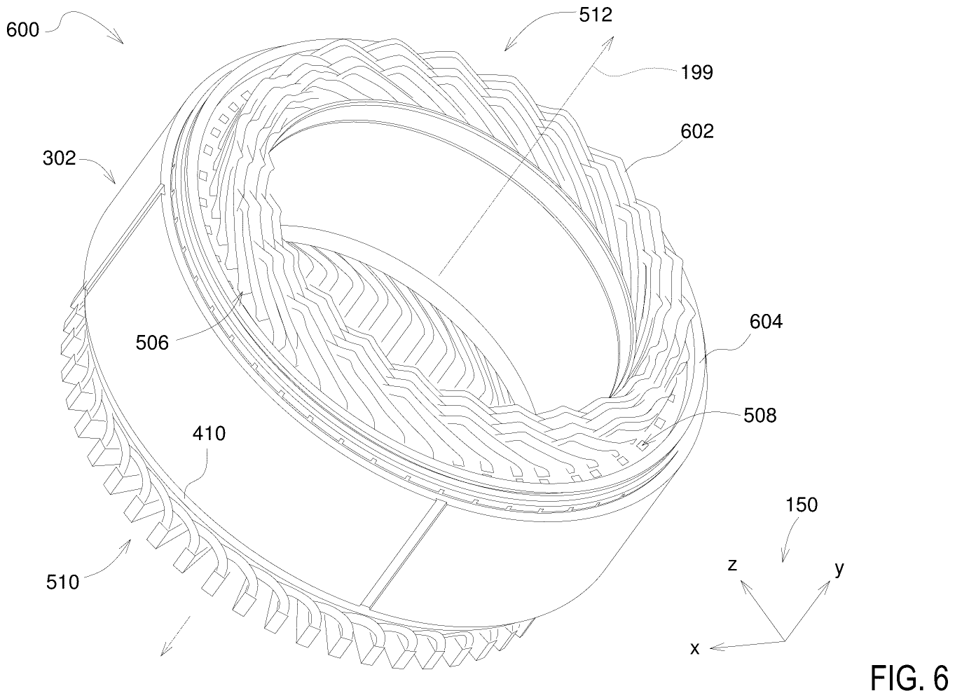

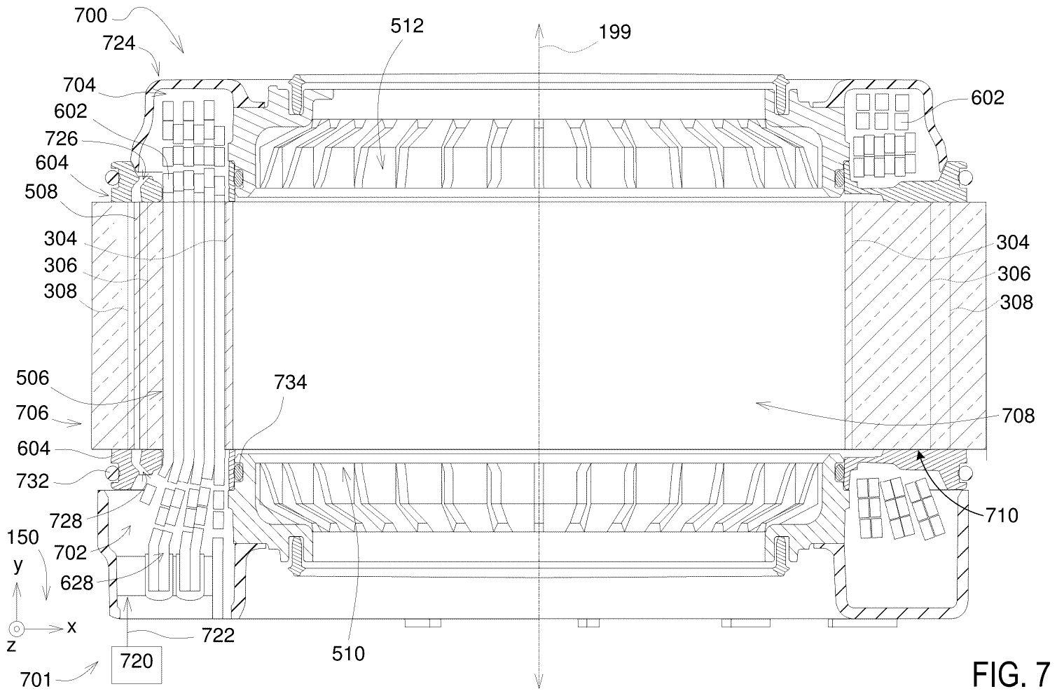

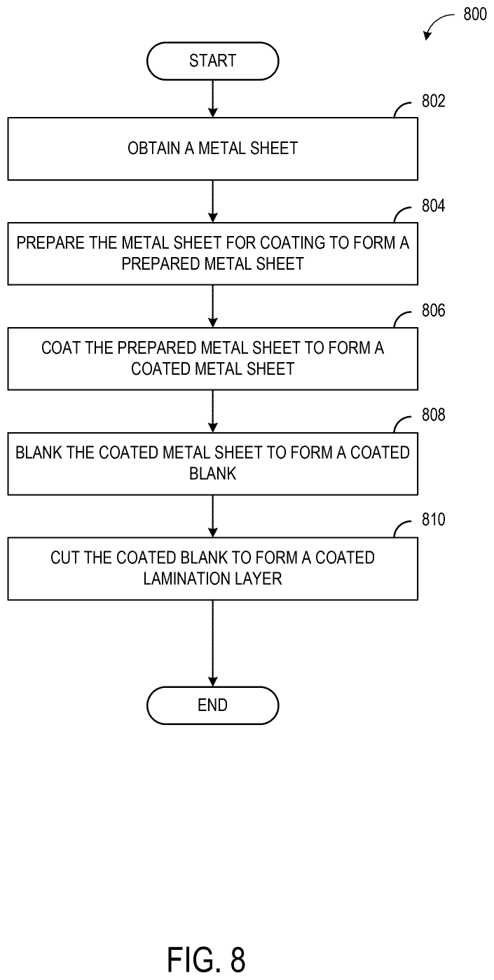

The following description relates to systems and methods for coated lamination layers of an electric motor with an immersion cooling system. An example of an electric motor with an immersion cooling system is shown schematically in FIG. 1 and to scale in FIG. 7. Immersion cooling may include fluid flowing through the stator rather than just surrounding ends of the stator. Fluid may leak from flow paths, such as channels and slots extending through the stator, towards a bore in the stator where a rotor is positioned, thereby imposing drag losses. The present disclosure relates to coated lamination layers to prevent such leaking of coolant fluid in immersion cooling systems. A coated lamination layer may comprise a lamination layer base and a sealing layer coated onto the lamination layer base. An example of the lamination layer is shown in FIG. 2 and examples of the coated lamination layer are depicted in FIGS. 3 and 4. The coated lamination layers may be stacked compressively and coaxially to form the stator of the electric motor. The coated lamination layers may fluidically seal coolant fluid from the bore of the stator where the rotor of the electric motor is positioned. In this way, drag loss on rotation of the rotor may be reduced while allowing coolant fluid to flow through the stator, thereby increasing efficiency. Further, coolant flowing through the stator may increase heat removed from windings extending through the stator, an example of which is shown in FIGS. 5 and 6. An exemplary method for manufacturing a coated lamination layer is shown as a flowchart in FIG. 8.

It is to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIG. 1 shows a schematic illustration of an electric machine 100 (e.g., an electric motor such as a traction motor). Reference axes 150 are provided in FIG. 1, as well as FIGS. 2-7. The z-axis may be a vertical axis (e.g., parallel to a gravitational axis), the x-axis may be a lateral axis (e.g., horizontal axis), and/or the y-axis may be a longitudinal axis, in one example. Additionally or alternatively, the y-axis may be parallel to an axial axis of the stator, while the z-axis and x-axis may be parallel to radial axes of the stator. However, the reference axes 150 may have other orientations, in other examples. Rotational axis 199 of the electric machine 100 is further provided for reference in FIG. 1 as well as FIGS. 2-7.

The electric machine 100 may be designed as an electric motor-generator and may be included in a system 102 which may take a variety forms. For instance, the electric machine 100 may be incorporated into an electric drive system of an electric vehicle (EV), in one example. As such, the electric machine 100 is a traction motor in such an example and the electric drive may further include a transmission (e.g., gearbox), for instance. In the EV example, the EV may be an all-electric vehicle (e.g., a battery electric vehicle (BEV)), in one example, or a hybrid electric vehicle (HEV) with an internal combustion engine, in another example. However, the electric machine 100 may be used in other suitable systems (e.g., stationary systems), in other examples, such as in industrial machines, agricultural systems, mining systems, and the like.

The electric machine 100 includes a rotor 104 that electromagnetically interacts with a stator 106 to drive rotation of a rotor shaft 108 that is included in the rotor. The rotor 104 may rotate about the rotational axis 199. The electric machine 100 in the illustrated example includes a housing 110 with an electrical interface 112 for the stator 106. The electrical interface 112 may be a multi-phase electrical interface with multiple electrical connectors 114. The electrical interface 112 is a three-phase interface, in the illustrated example. However, it will be understood that the electrical interface may be a six phase interface or a nine phase interface, in other examples. More generally, the electric machine 100 may be a multi-phase alternating current (AC) machine. However, in other examples, the electric machine 100 may be a direct current (DC) machine.

As illustrated in FIG. 1, the electric machine 100 may be electrically coupled to an inverter 116. The inverter 116 is designed to convert direct current (DC) power to alternating current (AC) power and vice versa. As such, the electric machine 100 may be an AC electric motor, as indicated above. However, in other examples, the electric machine 100 may be a DC electric motor (as previously indicated) and the inverter 116 may therefore be omitted from the system 102. The inverter 116 may receive electric energy from one or more energy storage device(s) 118 (e.g., traction batteries, capacitors, combinations thereof, and the like). Arrows 120 signify the electric energy transfer between the electric machine 100, the inverter 116, and the energy storage device(s) 118 that may occur during different modes of system operation.

The system 102 may additionally include a control sub-system 180 with a controller 182. The controller 182 includes a processor 184 and memory 186. The memory 186 may hold instructions stored therein that when executed by the processor 184 cause the controller 182 to perform the various methods, control techniques, and the like, described herein. The processor 184 may include a microprocessor unit and/or other types of circuits. The memory 186 may include known data storage mediums such as random access memory, read-only memory, keep alive memory, combinations thereof, and the like.

The controller 182 may receive various signals from sensors 188 that are positioned in different locations in the system 102. The sensors 188 may include an electric machine speed sensor, temperature sensor(s), an energy storage device state of charge sensor(s), an inverter power sensor, and the like. The controller 182 may also send control signals to various actuators 190 coupled at different locations in the system 102. For instance, the controller may send signals to the inverter 116 to adjust the rotational speed of the electric machine 100. In another example, the controller 182 may send a command signal to the electric machine 100 and/or the inverter 116 and in response motor speed may be adjusted. In yet another example, a flow rate of coolant fluid into the stator 106 may be adjusted in response to a temperature sensor reading. The other controllable components in the system 102 may function in a similar manner with regard to command signals and actuator adjustment.

The system 102 may also include one or more input device(s) 192 (e.g., an accelerator pedal, a brake pedal, a console instrument panel, a touch interface, a touch panel, a keyboard, combinations thereof, and the like). The input device(s) 192, responsive to user input, may generate a motor speed adjustment request.

The system 102 may further include a cooling system 122 adapted to deliver coolant fluid to the stator 106 such that coolant fluid flows through the stator 106. Arrow 124 signifies coolant fluid entering the housing 110 and the stator 106. The coolant fluid may flow through the stator 106 via pathways (e.g., via slots 506 and channels 508 of FIG. 5) extending through the stator 106 parallel with the rotational axis 199. To elaborate, the cooling system 122 may include a pump 125 that is configured to deliver coolant (e.g., oil or a water-glycol mixture) to the stator. The cooling system 122 may further include a sump in the housing 110, a filter, valve(s), and the like. Arrow 127 indicates the flow of coolant from the sump to the pump 125. In one example, the cooling system may be configured to flow coolant to an area surrounding stator end windings on one axial side of the machine. In such an example, the coolant then flows axially through passages in the stator lamination stack and then into another area that surrounds end windings on the opposing axial side of the machine.

The stator 106 may be laminated such that the stator 106 comprises a plurality of coated lamination layers in accordance with the present disclosure. In this way, the coated lamination layers may prevent the coolant fluid from flowing inwards towards the rotational axis 199 and increasing drag losses on rotation of the rotor 104 about the rotational axis 199. Further details as to the coated lamination layers are described below in regards to FIGS. 2-4.

Turning to FIG. 2, a lamination layer base 200 of a coated lamination layer in accordance with the present disclosure is shown. It will be understood that multiple coated lamination layers may be sequentially arranged to form a lamination stack, as expanded upon in greater detail herein.

The lamination layer base 200 may be annular in shape and centered about the rotational axis 199, where the annular shape is defined by an inner edge 202 with inner diameter 212 and an outer edge 204 with outer diameter 214. The inner edge 202 may define a center opening 220.

The lamination layer base 200 may include a flat surface 222 perpendicular with the rotational axis 199. The lamination layer base 200 may further include a second flat surface facing opposite the first flat surface 222. An area radially outside of the outer edge 204 may be referred to outside 224. In other words, the outside 224 may include all points in space radially further from the rotational axis 199 than the outer edge 204.

The lamination layer base 200 may include a plurality of radially arranged slot openings 206 and a plurality of radially arranged channel openings 208. In at least some examples, the slot openings 206 all have approximately the same shape and size. The slot openings 206 may be roughly rectangular in shape and may include notches 216. Similarly, the channel openings 208 may all have approximately the same shape and size. For example, the channel openings 208 may be rectangular. The channel openings 208 may be smaller than the slot openings 206. For example, an area of each of the channel openings 208 may be smaller than an area of each of the slot openings 206. Additionally or alternatively the slot openings 206 may be more elongated than the channel openings 208.

In at least some examples, there are the same number of slot openings 206 as channel openings 208. Further, the slot openings 206 and the channel openings 208 may be radially aligned along radial axes with the slot openings 206 positioned closer to the inner edge 202 than the channel openings 208. The slot openings 206 may be positioned at a distance 210 away from the inner edge 202. The distance 210 may be small, for example on the order of millimeters. In this way, conductors extending through the slot openings 206 may be in close proximity with a rotor circumferentially surrounded by the inner edge 202.

The slot openings 206 may be adapted to align with slot openings of other lamination layers to form slots, such as the slots 506 of FIG. 5, and the channel openings 208 may be adapted to align with channel openings of other lamination layers to form channels, such as the channels 508 of FIG. 5. As such, in other examples, the slot openings 206 and the channel openings 208 may be shaped and/or sized differently than the example shown in FIG. 2 depending on a desired geometry of the slots and the channels. For example, the slot openings 206 and the channel openings 208 may be square, hexagonal, or rounded such as circular or elliptical or rectangular with rounded corners without departing from the scope of the present disclosure. Further, in other examples, the slot openings 206 and the channel openings 208 may be arranged differently. For example, the channel openings 208 may be closer to the outer edge 204 than the slot openings 206. In another example, the channel openings 208 may be staggered with the slot openings 206 rather than radially aligned. The slot openings 206 and the channel openings 208 may be sized, shaped, and arranged according to desired flow of coolant fluid therethrough. Further details as to the slots and channels formed by the slot openings 206 and the channel openings 208 are described in regards to FIGS. 5-7.

The lamination layer base 200 may be part of a coated lamination layer in accordance with the present disclosure. FIGS. 3-4 show different examples of a sealing layer that is applied to the lamination layer base 200. It will be understood that multiple coated lamination layers may be sequentially arranged to form a lamination stack for a stator (e.g., the stator 106 shown in FIG. 1).

For example, turning to FIG. 3, a first example is shown of a coated lamination layer 300 formed via a sealing layer 302 applied to the lamination layer base 200. The sealing layer 302 may be a discontinuous layer that may be formed in a pattern. To elaborate, the sealing layer 302 includes a screen-printed coating that is applied with selected geometries. As such, the coating may protrude from the base in a direction along an axis that is parallel to the y-axis.

The sealing layer 302 may specifically be screen-printed onto the lamination layer base 200, or onto a blank sheet that is stamped into the shape of the lamination layer base 200 following screen printing onto the blank sheet. For example, the method 800 of FIG. 8 may be executed to produce the lamination layer base 200 with the sealing layer 302. However, it will be understood that the method 800 may be used to manufacture other suitable coated lamination layers.

The sealing layer 302 may specifically be formed as a screen-printed coating, as previously indicated. As used herein, a screen-printed coating may be a layer applied to a surface via a screen-printing process such that the layer covers at least part of the surface.

The sealing layer 302 may be at least partially constructed out of a fluoropolymer (e.g., a fluoroelastomer). Specifics as to the material construction of the sealing layer (e.g., the screen-printed coating) are expanded upon herein.

The sealing layer 302 may protrude axially (e.g., in the y-direction) from the lamination layer base 200. In other words, the sealing layer 302 may protrude perpendicularly from a surface of the lamination layer base 200 on which the sealing layer 302 is applied. For example, the sealing layer 302 may protrude by a distance (e.g., parallel with the rotational axis 199) between 3 μm and 30 μm. For another example, the sealing layer 302 may protrude by a distance between 7 μm and 24 μm. For yet another example, the sealing layer 302 may protrude by a distance between 18 μm to 30 μm or between 3 μm to 11 μm. The sealing layer 302 may protrude from the lamination layer base 200 by a distance less than a thickness of the lamination layer base 200 (e.g., dimension parallel with the y-axis). The lamination layer base 200 thickness may be between 0.01 mm and 1 mm, in at least some examples.

In this way, when compressive force is applied to a stack of the lamination layers 300 with sealing layers 302 interposed between lamination layer bases 200, the sealing layer 302 may concentrate pressure load to form a seal, thereby preventing fluid from crossing a boundary formed by the sealing layer 302 between regions defined by sections of the sealing layer 302. Thus, a pattern, or placement of sections, of the sealing layer 302 may determine where seals are formed in a stator. Exemplary stators include the stator 106 of FIG. 1 and the stator 512 shown in FIGS. 5-7. As such, the stators described herein may include multiple coated lamination layers in accordance with the present disclosure such as the coated lamination layer 300, the coated lamination layer 400 of FIG. 4, a combination thereof, and/or variations thereof. Thus, the stators may include a lamination stack, as previously discussed.

The sealing layer 302 may comprise one or more sections spaced away from one another. The sections may extend from a surface facing parallel with the rotational axis 199. Thus, the sections may extend in a direction parallel with the rotational axis 199. For example, the sections may include concentric rings. In the example shown in FIG. 3, the sealing layer 302 comprises three sections centered about the rotational axis 199 including a first section 304, a second section 306, and a third section 308. The first section 304, the second section 306, and the third section 308 may be shaped as an inner ring, a middle ring, and an outer ring, respectively. The first section 304, the second section 306, and the third section 308 may be circular with a first diameter 314, a second diameter 316, and a third diameter 318, respectively. The second diameter 316 may be greater than the first diameter 314 and the third diameter may be greater than the second diameter 316.

The first diameter 314, the second diameter 316, and the third diameter 318 may be sized to fluidically seal regions of the coated lamination layer 300. For example, a first region 340 between the first section 304 and the second section 306 may be fluidically sealed from the center opening 220. The first region 340 may further be sealed from a second region 342 between the second section 306 and the third section 308. In this way, fluid may flow from a first stator opening to a second stator opening via the first region 340. However, fluid may not flow from slot openings 206 to channel openings 208 or vice versa. In other words, fluid may not flow from the first region 340 to the second region 342 or vice versa.

The first section 304 may be positioned between the inner edge 202 and the slot openings 206. The first diameter 314 may be approximately the same as the inner diameter 212 such that the first section 304 is flush with the inner edge 202. A first thickness 324 of the first section 304 may be approximately the same as the distance 210 between the inner edge 202 and the slot openings 206 shown in FIG. 2. Alternatively, the first thickness 324 may be less than the distance 210.

The second section 306 may be positioned between the slot openings 206 and the channel openings 208 such that the second section 306 forms a seal between the slot openings 206 and the channel openings 208 when a stack of the coated lamination layer 300 with sealing layers 302 interposed between the lamination layer bases 200 is under axial compressive force. In at least some examples, a second thickness 326 of the second section 306 may be approximately the same as the first thickness 324. The second section 306 may be spaced away from the slot openings 206 and the channel openings 208. In other examples, the second section 306 may be flush with the slot openings 206 and/or the channel openings 208. For example, the second thickness 326 may be increased to cover up to an entire radial distance between the slot openings 206 and the channel openings 208. In another example, the second section 306 may be shifted by increasing or decreasing the diameter 316 such that the second section 306 is directly adjacent to the slot openings 206 or the channel openings 208.

The third section 308 may be positioned between the channel openings 208 and the outer edge 204 such that the third section 308 forms a seal between the channel openings 208 and the outer edge 204 when a stack of the coated lamination layer 300 with sealing layers 302 interposed between the lamination layer bases 200 is under axial compressive force. In at least some examples, a third thickness 328 of the third section 308 may be approximately the same as the second thickness 326 and the first thickness 324. However, in other examples, the first thickness 324, the second thickness 326, and the third thickness 328 may be different. The thicknesses 324, 326, 328 may be related to a concentration of pressure load when pressed against a flat surface, such as another lamination layer base 200. Thus, the thicknesses 324, 326, 328 may depend on a desired seal strength, and in some cases a length (e.g., dimension in the y-direction) by which the section extends from the surface of the lamination layer base 200.

The sealing layer 302 may include additional or alternative features than shown in FIG. 3. For example, the sealing layer 302 may include more or fewer sections than the first section 304, the second section 306, and the third section 308. Further, the sections may not be circular or ring-shaped. For example, the sections may be elliptical, polygonal, or other closed shapes according to a geometry of the lamination layer base 200. In at least some examples, the sections may surround a perimeter of the openings (e.g., channel openings 208, slot openings 206, or center opening 220) from which the section seals fluid from entering. For example, the first section 304 surrounds a perimeter of the center opening 220 to prevent fluid from entering radially inwards into a cylindrical bore formed by aligned center openings 220 of a plurality of the coated lamination layers 300. The sections may be closed shapes such that there are no gaps or open sides where fluid may cross the section. In this way, the sections may be boundaries across which fluid may not flow when the sections are pressed between two surfaces, such as two lamination layer bases, where the sections extend from one of the surfaces.

Turning to FIG. 4, a second example is shown of a coated lamination layer 400 that includes another example of a sealing layer 401. In the example, shown in FIG. 4, the sealing layer comprises the first section 304 and a set of sections 402. Rather than the second section 306 and the third section 308 sealing the channel openings 208 from other openings (e.g., center opening 220, slot openings 206, and outside of the outer edge 204) as shown in FIG. 3, the set of sections 402 may individually seal the channel openings 208 from each other and from the slot openings 206, for example by surrounding the channel openings 208. The set of sections 402 includes multiple sections that may be formed with a similar size and shape but are positioned in different locations. To elaborate, each of the sections in the set of sections 402 extends around (e.g., circumferentially extends around) one of the channel openings 208. Further, the center 403 of each of the sections 402 may be arranged along a circumferential line 404 (e.g., a circular line). Furthermore, the center 403 may be aligned (along an axis parallel to the y-axis) with the channel openings 208.

As previously discussed, each of the sections in the set of sections 402 may surround the channel openings 208 such that the channel openings fluidly seal the channel openings 208 from the center opening 220 and the slot openings 206 when a stack of the coated lamination layer 400 with sealing layers 302 interposed between the lamination layer bases 200 is under axial compressive force. The set of sections 402 may be elliptically shaped (e.g., circular) for example. In other examples, the fourth protrusions may take other closed shapes such polygonal shapes.

For example, each of the sections in the set of sections 402 may surround a single channel opening 208. However, in other examples, the set of sections 402 may each surround two or more channel openings. Further, the set of sections 402 may be circular as shown in FIG. 4, or in other examples, the set of sections 402 may take other shapes, including elliptical, polygonal, or any other shape that fully surrounds the perimeter of the channel openings 208.

The set of sections 402 may encompass a larger area than the channel openings 208. In this way, the set of sections 402 may be spaced away from edges defining the channel openings 208. However, in other examples, the set of sections 402 may be smaller in size and shaped similarly to the channel openings 208 such that the set of sections 402 border the perimeters of the channel openings 208.

Further configurations of sealing layers are possible without departing from the present disclosure. For example, similar to the set of sections 402 surrounding the channel openings 208, a border of any shape may be formed around each of the slot openings 206 in some examples additionally or alternatively to the first section 304. In this way, slot openings 206 may be sealed from one another when compressive force is applied to a stack of the coated lamination layers with sealing layers 302 interposed between the lamination layer bases 200. Further, in some examples, the sealing layer 302 may comprise a combination of the features shown in FIGS. 3 and 4. For example, the sealing layer 302 may comprise the first section 304, the set of sections 402, and the third section 308. Other combinations may be implemented to form seals between the center opening 220 and areas radially outside of the center opening 220, and between the slot openings 206 and the channel openings 208. Further, a seal may be formed between the channel openings 208 and areas radially outside of the outer edge 204.

Further still, the sealing layer 302 may be applied to one side of the lamination layer base 200 as described above, or to both sides of the lamination layer base 200. For example, some components of the sealing layer may be on a first side of the lamination layer base 200 facing the positive y-direction and a second side of the lamination layer base 200 facing the negative y-direction. For example, the first section 304 may be applied to the first side and the fourth sections may be applied to the second side. Applying the sealing layer 302 to a single side (e.g., the first side or the second side) may be less complex in a manufacturing process. However, sealing layers 302 may be configured on both sides.

When stacked to form a stator, such as a stator 500 shown in FIG. 5, coated lamination layers may be positioned between the lamination layer bases 200. In this way, a coaxial stack of the coated lamination layers may alternate along the axis upon which the stack is centered between lamination layer bases and sealing layers, thus forming seals between the lamination layer bases at interfaces where the sealing layers are in face sharing contact with the lamination layer bases. Further, the lamination layer bases may be spaced apart from other lamination layer bases, rather than in face sharing contact, due to the sealing layers between the lamination layer bases.

The coated lamination layers may be stacked with one on top of another. A top of a coated lamination layer comprising a base and a sealing layer protruding therefrom may be a surface of the coated lamination layer facing a first axial direction and a bottom of the coated lamination layer may be a second surface of the lamination layer facing a second axial direction opposite the first direction. For example, a top of a coated lamination layer comprising a base and a sealing layer protruding therefrom may be an end of the sealing layer sections and a bottom of the coated lamination layer may be a side of the lamination layer base facing away from the sealing layer. The top of a coated lamination layer may be in face sharing contact with the bottom of another coated lamination layer when stacked.

For example, a first coated lamination layer having a first sealing layer protruding from a first base and a second coated lamination layer having a second sealing layer protruding from a second base may be stacked with the first coated lamination layer such that the first sealing layer protrudes from the first base away from the stack and the second sealing layer is interposed between and in face sharing contact with both the first base and the second base. In this way, the second sealing layer may concentrate pressure load onto locations where the second sealing layer is in face sharing contact with the first base and the second base, thereby forming a seal between the first base and the second base. Further, the second sealing layer may space the first base and the second base apart. A third coated lamination layer having a third sealing layer and a third base may be added to the stack, where the third coated lamination layer is positioned such that the third sealing layer is interposed between and in face sharing contact with both the second base and the third base. The third coated lamination layer may not be in face sharing contact with the first coated lamination layer. The third coated lamination layer and the first coated lamination layer may sandwich the second coated lamination layer. In this way, the third sealing layer may concentrate pressure load onto interfaces where the third sealing layer is in face sharing contact with the second base and the third base, thereby forming a seal between the second base and the third base. Further, the second sealing layer may space the second base and the third base apart. Any number of coated lamination layers may be stacked in this way.

Turning to FIG. 5, a perspective view is shown of an example of a stator 500, where the stator includes a stack of coated lamination layers, each coated lamination layer including the lamination layer base 200 and the sealing layer 302. It will be understood that the stator 500 serves as an example of the stator 106 shown in FIG. 1 but may be used in other suitable electric machines.

As described above, the sealing layer 302 may be a screen-printed coating applied onto a surface of the lamination layer base 200. For example, the coated lamination layers may be the coated lamination layer 300 or the coated lamination layer 400 of FIGS. 3 and 4, respectively, other examples of coated lamination layers in accordance with the present disclosure, or a mixture thereof.

The lamination layer bases 200 may be aligned coaxially and centered about the rotational axis 199. In this way, the center openings 220 may align to form a cylindrical bore 504 extending axially through an entire length 502 of the stator 106. Thus, the bore 504 may be defined by the inner edges 202 of the lamination layer bases 200. Further, the bore 504 may be defined by sections sealing the bore 504. As such, a cylindrical surface defining the bore 504 may include alternating lamination layer bases and sealing layer sections.

A rotor such as the rotor 104 of FIG. 1 may be positioned within the bore 504, as described further below in regards to FIG. 7. As shown in FIG. 5, the outer edges 204 may align such that a discontinuous cylindrical surface is formed with gaps axially between outer edges 204 of the lamination layer bases 200 due to the sealing layer 302 interposed between each set of adjacent lamination layer bases 200. For example, the gaps may be approximately the same width as the distance by which sections (e.g., the first section 304, the second section 306, the third section 308, and/or the set of sections 402) of the sealing layer 302 extend from surfaces (e.g., the first flat surface 222) of the lamination layer bases 200.

Additionally, aligned openings may form the bore 504, slots 506, and channels 508. Aligned openings may include openings with areas overlapping. Aligned openings may create through holes in the stator 106 such as the bore 504, the slots 506, and the channels 508. For example, the lamination layer bases 200 may be angularly aligned such that areas of the slot openings 206 overlap to form the slots 506 and areas of the channel openings 208 overlap to form the channels 508. The slots 506 and the channels 508 may extend axially though the length 502 of the stator 106. As such, the slots 506 and the channels 508 may be through holes defined by the slot openings 206 and the channel openings 208, respectively. In this way, the channel openings 208 of each channel 508 may be fluidically coupled such that fluid may flow through the channels 508 parallel with the rotational axis 199. Similarly, the slot openings 206 of each slot 506 may be fluidically coupled such that fluid may flow through the slots 506 parallel with the rotational axis 199. Further, other features of the lamination layer bases 200 may align. For example, notches 218 may angularly align to form indents 518 which extend axially, parallel with the length 502.

Compressive force may be applied axially to a first axial end 510 of the stator 106 and a second axial end 512 of the stator 106 opposite the first axial end 510. In this way, the coated lamination layers may be compressively stacked such that the sealing layers 302 concentrate pressure load at locations where the sealing layer sections contact the lamination layer bases, thereby forming a seal at those locations. Thus, as described above, a pattern of the sealing layer 302 may determine sealing locations.

The sealing locations may be chosen based on where radial flow of fluid is not desired. The sealing layers 302 may fluidically seal the slots 506 from the channels 508 in a radial direction. Further, the sealing layers 302 may fluidically seal the center openings 220 from areas radially outside of the bore 504, including the slots 506, the channels 508, and the outside 224 in a radial direction. Further still, the sealing layers 302 may fluidically seal the outside 224 from the channels 508, the slots 506, and the bore 504 in a radial direction. For example, the first section 304 of FIGS. 3 and 4 may prevent radial flow of fluid from the channels 508 or the slots 506 to the bore 504. The second section 306 of FIG. 3 may prevent radial flow of fluid between the slots 506 and the channels 508 (e.g., from the slots 506 to the channels 508 and from the channels 508 to the slots 506). The third section 308 of FIG. 3 may prevent radial flow of fluid from the channels 508 to the outside 224. The set of sections 402 of FIG. 4 may prevent radial flow of fluid between the slots 506 and the channels 508 and from the channels 508 to the outside 224.

Turning to FIG. 6, a perspective view 600 is shown of the stator 106 with windings 602 extending through the slots 506. The windings 602 may extend axially through the entire stator 106 and beyond one each of the first axial end 510 and the second axial end 512. The windings 602 may further extend through an end piece 604 (e.g., end plate) on either end of the stator 106. The end pieces 604 may be shaped similarly to the lamination layer bases 200 such that openings in the end pieces 604 align with openings of the lamination layer bases 200, such as the slot openings 206 and the channel openings 208, to extend the channels 508 and the slots 506.

Turning to FIG. 7, a cross section view of an example of an electric machine 700 with a cooling system 701 is shown. The cutting plane for the cross-sectional view extends through the central axis 199 of the electric machine. The electric machine 700 serves as an example of the electric machine 100 shown in FIG. 1, the other electric machines described herein, and/or combinations of the electric machines. The electric machine 700 includes the stator 706 and the rotor 708 positioned within the stator, where the stator and the rotor are coaxial and centered about the rotational axis 199. The electric machine 700 further includes a first reservoir 702 (e.g., end winding cooling chamber) at the first axial end 510 and a second reservoir 704 at the second axial end 512. The windings 602 extend beyond the first axial end 510 and the second axial end 512. In this way, the windings 602 extend into the first reservoir 702 and the second reservoir 704.

The example shown in FIG. 7 includes the stator 706 includes a lamination stack 710 that includes multiple coated lamination layer 300 of FIG. 3 coaxially stacked. In this way, first sections 304 align parallel with the rotational axis 199, second sections 306 align parallel with the rotational axis 199, and third sections align parallel with the rotational axis 199. Further, the coated lamination layers 300 may be compressively stacked such that the first sections 304 form a seal between the rotor 104 and the slots 506, the second sections form a seal between the slots 506 and the channels 508, and the third sections 308 form a seal between the channels 508 and areas radially further from the rotational axis 199 than the third sections 308. Locations of the first sections 304, the second sections 306, and the third sections 308 are represented by dashed lines in FIG. 7. However, the dashed line representation does not limit the number of coated lamination layers 300 or thickness of the sealing layers 302. For example, there may be several hundred coated lamination layers with sealing layer 302 thickness small enough (e.g., on the order of 10 μm) that the sealing layers 302 may not be visible unless depicted in an enlarged or zoomed in view of the cross section of FIG. 7.

The cooling system 701 may include a pump 720 that delivers coolant to the stator 706 as denoted via arrow 722. As previously discussed, the pump 720 may be in fluidic communication with a sump that is formed in a housing 724. The pump 720 may specifically deliver coolant to the reservoir 702 via a duct, conduit, channel, etc., in one example. Continuing with such an example, the coolant may then flow into the channels 508 and then into the reservoir 704 via a nozzle 726, in one example. In an alternate example, the pump 720 may deliver coolant to the channels 508. In such an example, the coolant may be delivered to a mid-point of the channels and coolant may flow axially outward through the channels towards the end windings on the opposing axial sides of the stator. Further in such an example, a nozzle 728 may direct coolant towards the end windings 628 in the reservoir 702. Further, seals 732 and 734 may be positioned in the end plates 604. In such an example, the nozzles 726 and 728 spray or otherwise flow coolant toward end windings on opposing axial sides of the stator.

In the cooling system, the coolant fluid may travel through the slots 506 to surround the windings 602 along a full length (e.g., a dimension parallel with the y-axis) of the windings 602, thereby increasing heat removal compared to cooling systems where coolant fluid is allowed to contact the ends of the windings but not enter the slots where the windings extend through the stator. Additionally, coolant fluid may travel through the channels 508 to further increase heat removed. Coolant fluid may flow from the channels 508 to the slots 506 or vice versa via the first reservoir 702 or the second reservoir 704. However, due to the second sections 306, the coolant fluid may not directly flow from the channels 508 to the slots 506 or vice versa, for example in a lateral direction in the frame of reference of FIG. 7.

The first reservoir 702 and the second reservoir 704 may be fluidically coupled via the slots 506 and the channels 508. For example, coolant fluid may flow from the first reservoir 702 to the second reservoir 704 via the slots 506 and return from the second reservoir 704 to the first reservoir 702 via the channels 508. Additionally or alternatively, the coolant fluid may flow from the first reservoir 702 to the second reservoir 704 via the channels 508 and return from the second reservoir 704 to the first reservoir 702 via the slots 506. Additionally, fluid may flow radially between, but not through, the sections 304, 306, and 308. For example, coolant fluid may flow in any direction (e.g., radially, angularly, etc.) within the first region 340 between the first section 304 and the second section 306. Likewise, coolant fluid may flow in any direction within the second region 342 between the second section 306 and the third section 308.

However, as described above, fluid may not cross boundaries defined by sections of the sealing layer 302, for example the first section 304, the second section 306, and the third section 308.

As described above, the sealing layer 302 may be a screen-printed coating applied to a metal surface, such as the flat surface 222 of FIGS. 3-4.

Turning to FIG. 8, a method 800 is shown for manufacturing a coated lamination layer in accordance with the present disclosure by screen-printing a sealing layer, such as the sealing layer 302. The method 800 may be carried out via a process line with several manufacturing units. The method 800 may be executed automatically, manually, or a mixture thereof. A result of the method 800 may be one or more coated lamination layers comprising a lamination layer base and a sealing layer in the form of a screen-printed coating, such as the coated lamination layer 300 or the coated lamination layer 400 of FIGS. 3 and 4, respectively.

The method 800 begins at 802, wherein a sheet of metal is obtained. The metal sheet may have a thickness smaller than the length and width such that the metal sheet is thin and flat. The thickness may be the desired thickness for a coated lamination layer of the present disclosure. For example, the thickness may be approximately 0.2 mm. In other examples, the thickness may be between 0.05 mm and 1.0 mm. The metal sheet may comprise a substantially pure metal or metal alloy.

The method 800 proceeds to 804, wherein the metal sheet is prepared for coating. Preparing the metal sheet for coating may include cleaning the metal sheet to remove impurities such as dust, dirt, debris, and any other undesired materials present on a surface of the metal sheet. Cleaning may include physical and chemical cleaning methods. Preparing the metal sheet for coating may further include preparing the metal sheet for adhesive application. For example, the adhesive (e.g., epoxy adhesive) may be applied in order to bond a coated lamination layer resulting from the method 800 with another lamination layer. Application of the adhesive may occur at any point in the method 800 following preparation at 802. Preparing the metal sheet for coating may further comprise treating the metal in locations where a sealing layer is coated onto the metal sheet in a subsequent step of the method 800. For example, pre-coating treatment may include surface treatments to ensure proper bonding (e.g., physical and/or chemical bonding) of the metal sheet with the coating material.

The method 800 proceeds to 806, wherein the metal sheet is coated to form a coated metal sheet. For example, the metal sheet may be coated via a screen-printing process where a template is used to apply a coating to the metal sheet in a desired pattern. The coating may form a sealing layer on the metal sheet, such as the sealing layer 302 of FIGS. 3 and 4. As such, the template may include discontinuous patterns comprising rings or other closed shapes according to desired seal locations and geometry of a lamination layer base such as the lamination layer base 200 that is cut out in a subsequent step of the method 800. All sections of the sealing layer (e.g., the first section 304, the second section 306, the third section 308, and/or the set of sections 402) may be screen-printed concurrently, in at least some examples. However, in other examples, the sections may be printed sequentially.

The screen-printing process may include roll coating. In some examples, two or more repetitions of a sealing layer pattern (e.g., three concentric circles such as shown in FIG. 3) may be coated onto the same metal sheet, with spaces in between the patterns to allow for blanking and stamping of the metal sheet into the lamination layer base (e.g., lamination layer base 200) shape in subsequent steps of the method 800 to form two or more coated lamination layers. Due to the coating material comprising rubber, the coating may fill pores in the metal sheet during coating, thereby increasing a sealing effect by blocking fluid leaks through the pores. For example, other materials which do not move with some fluidity into pores of the metal during coating may result in inadequate seals between lamination layers. Thus, the coating material may include rubber (e.g., polyisoprene) or another material conducive to the coating process with plastic and elastic qualities. In this way, the plastic nature of the coating material may allow the coating to flow such that the coating matches a surface finish profile of the metal. For example, the coating material may move with at least some fluidity during the coating (e.g., roll coating) process such that pores and surface imperfections in the metal are filled in by the coating material, thereby reducing a likelihood of fluid leaking between the metal and the coating (e.g., sealing layer). Due to the plastic nature of rubber or other coating material, the coating material may flow plastically during coating and a seal may be effectively formed between the sealing layer and another metal surface when compressed together such that fluid may not flow across the sealing layer between the two metal surfaces. Further, the elastic nature of the coating material may increase durability of the seal. Further, the coating material may not be liquid permeable to prevent leaking through the seal.

The result of step 806 may be the formation of a coated metal sheet with the prepared metal sheet with a sealing layer coated thereon, where the sealing layer partially covers the metal sheet. The sealing layer may be a screen-printed layer of thickness between 3 μm and 30 μm that penetrates into pores and other surface irregularities inherently present in the metal sheet on which the screen-printed coating is applied. In other words, a distance by which the sealing layer protrudes from the metal sheet may be between 3 μm and 30 μm. The thickness of the sealing layer may be approximately the same across each sealing layer pattern.

The method 800 proceeds to 808, wherein the coated metal sheet is blanked to form a coated blank. For example, a piece of the coated metal sheet may be punched out from the coated metal sheet according to a location of the sealing layer coating pattern. The piece may also be removed from the coated metal sheet by a different cutting action than punching.

Using the sealing layer pattern example shown in FIG. 3 with three concentric circles as an example, a circular piece of metal may be cut out of the coated metal sheet where the circular piece is defined by the outer edge 204 of FIGS. 2-4. As such, the circular piece may be concentric with the three concentric circles and may comprise modifications to the circular shape such as the notches 218 of FIG. 2. Using the sealing layer pattern example shown in FIG. 4 as another example, a circular piece of metal may be punched out of the coated metal sheet where the circular piece is defined by the outer edge 204 of FIGS. 2-4 and the outer edge 204 is equidistantly spaced from each of the radially arranged set of sections. In other examples, the piece punched out of the metal may comprise a different shape and may be oriented relative to the sealing layer pattern coated on the metal. In this way, a blanked coated metal sheet may resemble a coated lamination layer without channel openings or slot openings.

The method 800 proceeds to 810, wherein the coated blank is cut to form a coated lamination layer. For example, slot openings and channel openings such as the slot openings 206 and the channel openings 208, respectively, of FIG. 2 may be cut out of the coated blank. For example, cutting may include laser cutting, jet cutting, stamping, or the like. The coated lamination layer may resemble the examples provided in FIGS. 3 and 4.

The method 800 is exemplary and non-limiting as to manufacturing of a coated lamination layer in accordance with the present disclosure. Steps of the method 800 may be completed in different orders than shown in the flowchart in FIG. 8 without departing from the scope of the present disclosure. For example, the metal sheet may be blanked before prepared. Additionally or alternatively, the metal sheet may be cut before prepared. Additionally or alternatively, the metal sheet may be coated following banking and/or cutting. Additionally or alternatively, the metal sheet may be blanked after cutting. Other orders of steps are also possible. Further, there may be additional steps or omitted steps without departing from the scope of the present disclosure.

The technical effect of the coated lamination layer described herein is to allow coolant fluid to flow through a stator in order to remove heat from the stator and prevent the coolant fluid from leaking towards a rotor positioned within the stator. In this way, heat removed may be increased and drag losses due to contact between coolant fluid and the rotor may be reduced (e.g., prevented), thereby increasing efficiency. The coated lamination layer may comprise a sealing layer and a lamination base layer, where the sealing layer comprises one or more sections partially covering a surface of a lamination base layer (e.g., metal layer). In this way, when a plurality of the coated lamination layers is compressively stacked, pressure load may be concentrated at the sections to form seals where coolant fluid may not cross. Further, the sealing layer may comprise a coating material with plastic and elastic properties such that the sealing layer may be coated (e.g., screen-printed) onto a metal layer with the coating material penetrating into pores and other surface irregularities to match the surface finish profile of the metal layer, thereby preventing fluid leaks between the sealing layer and the metal layer.

FIGS. 1-7 show example configurations with approximate position. FIGS. 2-7 are shown approximately to scale (aside from the schematically depicted components); though other relative dimensions may be used. As used herein, the term “approximately” is construed to mean plus or minus five percent of the range unless otherwise specified.

If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

The invention is further described in the following paragraphs. In one aspect, an electric machine system is provided that comprises a coated lamination layer, including: a lamination layer base of annular shape defined by an inner edge and an outer edge with a plurality of radially arranged slot openings and a plurality of radially arranged channel openings; and a sealing layer protruding from a surface of the lamination layer base; wherein the sealing layer includes a screen-printed coating. In one example, the screen-printed coating may comprise a first section positioned between the inner edge and the plurality of radially arranged slot openings. In one example, the screen-printed coating may further comprise a second section positioned between the plurality of radially arranged slot openings and a third section positioned between the plurality of radially arranged channel openings and the outer edge. In one example, the first section, the second section, and the third section may be closed shapes spaced away from one another. In one example, the first section, the second section, and the third section may be shaped as rings centered about a rotational axis extending through a center of the lamination layer base. In one example, the first section may have a first diameter, the second section has a second diameter greater than the first diameter, and the third section has a third diameter greater than the second diameter. In one example, the first diameter may be approximately the same as an inner diameter of the inner edge. In another example, the screen-printed coating may further comprise a plurality of fourth sections surrounding the plurality of radially arranged channel openings. In one example, each of the plurality of fourth sections may surround one of the plurality of radially arranged channel openings. In one example, the first section and the plurality of fourth sections may be closed shapes spaced away from one another. In another example, the sealing layer may protrude by a distance between 3 μm to 30 μm from the lamination layer base. In another example, the lamination layer base may comprise metal and the sealing layer comprises a coating material with plastic and elastic properties such that the sealing layer matches a surface finish profile of the metal.

In another aspect, a method for manufacture of a coated lamination layer of an electric motor is provided that comprises preparing a metal sheet for coating to form a prepared metal sheet; coating the prepared metal sheet to form a coated metal sheet; blanking the coated metal sheet to form a coated blank; and cutting the coated blank to form the coated lamination layer. In another example, preparing the metal sheet for coating may comprise cleaning the metal sheet, preparing the metal sheet for application of an adhesive, and treating areas of the metal sheet where a screen-printed coating is applied during coating the prepared metal sheet. In another example, coating the prepared metal sheet may comprise screen-printing a coating onto the metal sheet to form a sealing layer on the metal sheet. In yet another example, coating the prepared metal sheet may further comprise flowing the coating into pores of the metal sheet. In another example, cutting the coated blank may comprise forming a plurality of slot openings and a plurality of channel openings. In another example, the method may further comprise forming a stator by stacking a plurality of the coated lamination layer.

In another aspect, a stator is provided that comprises a plurality of coated lamination layers, wherein each of the plurality of coated lamination layers comprises: a lamination layer base including an annular shape with a center opening, a plurality of slot openings radially arranged about the center opening, and a plurality of channel openings radially arranged about the center opening; and a sealing layer comprising a screen-printed coating on a surface of the lamination layer base; wherein the plurality of coated lamination layers is stacked coaxially about a rotational axis such that the center openings align to form a bore, the slot openings align to form slots extending through the stator and the channel openings align to form channels; and wherein the screen-printed coating is positioned between adjacent lamination layer bases such that the screen-printed coating seals regions of the stator under axial compressive force. In one example, the sealing layer protrudes axially from the surface of the lamination layer base, and wherein the screen-printed coating protrudes by a distance less than a thickness of the lamination layer base. In one example, the screen-printed coating may comprise a first section bordering an inner edge of the lamination layer base that radially seals the slots from the bore. Further, in one example, the screen-printed coating may further comprise a second section positioned between the slot openings and the channel openings such that the slots and the channels are radially sealed.

In one aspect, a vehicle is provided that comprises an electric motor including a rotor positioned within and coaxial with a stator and adapted to rotate about an axis of rotation, the stator comprising: a plurality of coated lamination layers each comprising a lamination layer base and a screen-printed coating on a surface of the lamination layer base, wherein the plurality of coated lamination layers is stacked compressively and coaxially about the axis of rotation with aligned openings that form a bore, channels, and slots extending axially through the stator; a first reservoir at a first axial end of the stator and a second reservoir at a second axial end of the stator opposite the first axial end, wherein the first reservoir and the second reservoir are fluidically coupled via the slots and the channels; and an immersion cooling system adapted to spray coolant fluid onto ends of windings extending through the slots from the first reservoir to the second reservoir. In one example, the slots and the channels may be sealed such that fluid does not flow radially between the slots and the channels. Further, in one example, the screen-printed coating may comprise a first section positioned between the bore and the slots and a second section positioned between the slots and the channels. Further, in one example, the screen-printed coating may further comprise a third section positioned between the channels and an outside of the stator, and wherein fluid is sealed form flowing radially between a first region formed between the first section and the second section and a second region formed between the second section and the third section. In yet another example, the coolant fluid may flow from the first reservoir to the second reservoir via the channels and from the second reservoir to the first reservoir via the slots.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric machine system, comprising:
a coated lamination layer, including:
a lamination layer base of annular shape defined by an inner edge and an outer edge with a plurality of radially arranged slot openings and a plurality of radially arranged channel openings; and
a sealing layer protruding from a surface of the lamination layer base;
wherein the sealing layer includes a screen-printed coating.

2. The electric machine system of claim 1, wherein the screen-printed coating comprises a first section positioned between the inner edge and the plurality of radially arranged slot openings.

3. The electric machine system of claim 2, wherein the screen-printed coating further comprises a second section positioned between the plurality of radially arranged slot openings and a third section positioned between the plurality of radially arranged channel openings and the outer edge.

4. The electric machine system of claim 3, wherein the first section, the second section, and the third section are closed shapes spaced away from one another.

5. The electric machine system of claim 3, wherein the first section, the second section, and the third section are shaped as rings centered about a rotational axis extending through a center of the lamination layer base.

6. The electric machine system of claim 5, wherein the first section has a first diameter, the second section has a second diameter greater than the first diameter, and the third section has a third diameter greater than the second diameter.

7. The electric machine system of claim 6, wherein the first diameter is approximately the same as an inner diameter of the inner edge.

8. The electric machine system of claim 2, wherein the screen-printed coating further comprises a plurality of fourth sections surrounding the plurality of radially arranged channel openings.

9. The electric machine system of claim 8, wherein each of the plurality of fourth sections surrounds one of the plurality of radially arranged channel openings.

10. The electric machine system of claim 8, wherein the first section and the plurality of fourth sections are closed shapes spaced away from one another.

11. The electric machine system of claim 1, wherein the sealing layer protrudes by a distance between 3 μm to 30 μm from the lamination layer base.

12. The electric machine system of claim 1, wherein the lamination layer base comprises metal and the sealing layer comprises a coating material with plastic and elastic properties such that the sealing layer matches a surface finish profile of the metal.

13. A method for manufacture of a coated lamination layer of an electric motor, comprising:
preparing a metal sheet for coating to form a prepared metal sheet;
coating the prepared metal sheet to form a coated metal sheet;
blanking the coated metal sheet to form a coated blank; and
cutting the coated blank to form the coated lamination layer.

14. The method of claim 13, wherein preparing the metal sheet for coating comprises cleaning the metal sheet, preparing the metal sheet for application of an adhesive, and treating areas of the metal sheet where a screen-printed coating is applied during coating the prepared metal sheet.

15. The method of claim 13, wherein coating the prepared metal sheet comprises screen-printing a coating onto the metal sheet to form a sealing layer on the metal sheet.

16. The method of claim 13, wherein coating the prepared metal sheet further comprises flowing the coating into pores of the metal sheet.

17. The method of claim 13, wherein cutting the coated blank comprises forming a plurality of slot openings and a plurality of channel openings.

18. The method of claim 13, wherein the method further comprises forming a stator by stacking a plurality of the coated lamination layer.

19. A stator, comprising:
a plurality of coated lamination layers, wherein each of the plurality of coated lamination layers comprises:
a lamination layer base including an annular shape with a center opening, a plurality of slot openings radially arranged about the center opening, and a plurality of channel openings radially arranged about the center opening; and
a sealing layer comprising a screen-printed coating on a surface of the lamination layer base;
wherein the plurality of coated lamination layers is stacked coaxially about a rotational axis such that the center openings align to form a bore, the slot openings align to form slots extending through the stator and the channel openings align to form channels; and
wherein the screen-printed coating is positioned between adjacent lamination layer bases such that the screen-printed coating seals regions of the stator under axial compressive force.

20. The stator of claim 19, wherein the sealing layer protrudes axially from the surface of the lamination layer base, and wherein the screen-printed coating protrudes by a distance less than a thickness of the lamination layer base.
